(19) United States
(12) Patent Application Publication
(10) Pub. No.: US 2009/0193266 A1
(43) Pub. Date: Jul. 30, 2009

(54) Access control for protected and clear AV content on same storage device

(76) Inventors: Melvin G. Gable, Cowan Heights, CA (US); Jian Chen, Irvine, CA (US)

Correspondence Address: HENNEMAN & ASSOCIATES, PLC, 70 N. MAIN ST., THREE RIVERS, MI, 49093, US

(21) Appl. No.: 12/011,608

(22) Filed: Jan. 28, 2008

(51) Int. Cl. G06F 12/14; G06F 21/24

(52) U.S. Cl. 713/193; 726/27

(57) ABSTRACT

A method and apparatus for storing both protected and clear data on a single storage device 34. The apparatus includes storage media 34 for storing digital material such as video, sound, pictures and text. The media is partitioned into protected 94 and unprotected areas 98. The apparatus further includes circuitry 10 for accessing, decrypting and encrypting data. This circuitry includes a controller 16 with associated ROM 18 for directing the controller 16 and communication ports 20 for connecting to a source of content 12 and a sink 14 for storage. The method includes partitioning a storage device into clear 98 and protected areas 94 and directing protected data to the protected area 94 and clear data to the clear area 98. One embodiment includes an encrypted directory in the protected area 94 and a conventional directory in the clear area 98.

### BACKGROUND OF THE INVENTION

1. Field of Invention

This invention relates generally to digital video and audio reproduction systems such as those used for home entertainment, and particularly to an apparatus and method for access control of both copy-protected and unprotected information on the same storage device.

2. Background Art

Video and audio entertainment content, comprising audiovisual (AV) objects such as movies, video programs, pictures, and music, is protected by copyright law and generally distributed with a limited use license. Formerly, some degree of security against copyright violation was afforded by the practical difficulty of making good copies, but now, content is produced and handled in the form of digital signals, which can be perfectly copied. Thus copy protection (also known as content protection) has become an important link in the distribution chain of AV content to end users. In current art, digital AV content is transmitted to the user, for example to the home, over several different commercial distribution channels including cable, satellite, television (TV) and radio broadcast, short range wireless link, internet connection, and also delivered on prerecorded disks and other media. Many consumers want to store this content and move it between storage devices such as hard disk drives (HDDs), digital video disk (DVD) recorders (DVRs), personal computers (PCs), rather than use it when received, for greater convenience and accommodation of personal preferences about when to watch a movie or listen to music, and how to organize one's collection of AV objects, and on what type of media. Storing is associated with copying, and this creates the possibility of license violation. Consequently, in order to help prevent the making of unauthorized and unlicensed copies, the industry—including AV content owners, commercial content distributors, and consumer electronics manufacturers—have implemented content protection means in digital AV consumer electronic devices (also called components), as well as in the information signal, in conformance with Digital Rights Management (DRM) needs and industry standards, for example according to the Digital Transmission Content Protection (DTCP) specification known in the art. The protection means can potentially be included in all digital electronic devices that can be used to receive, store, and play (view) commercially supplied digital AV content, and also in the signal interfaces of PCs, which can be employed to edit and store AV content before or after viewing.

However, besides handling copy protected digital AV content from commercial sources, the same electronic devices can also be used to store, edit, and play digital AV content that does not need DRM, (clear data) being authored, generated, and produced by people for their own private use, with the help of digital video cameras, microphones, and PCs running various synthesizing and editing programs. Such devices are conventionally employed for producing and editing content such as AV records of family events, travel, personal albums, AV clips to share with friends and post on the internet, and hobby material. Further, owing to the high quality of digital AV consumer devices and PC software now widely available at moderate cost, the hobby use of such devices can merge into production of original works of art and educational and professional AV materials. The DTCP specification does provide for content to be labeled as “copy-free”, also known as unprotected and “clear” (of limitations on copying). Accordingly, content produced and owned by a user, and also that portion of commercially distributed content which is made freely available for public use by a content owner, can be so labeled.

TABLE 1

| | OWNERSHIP | DTCP |
|---|---|---|
| Source of | and | requirement |
| AV CONTENT | USE rights | for handling |
| Commercially | Copyrighted, | Protected |
| supplied | limited license | |
| | Free | Clear |
| User-produced | User-owned | |

Table 1 summarizes the types of digital AV content handled (received, transmitted, stored) by AV devices, and their DTCP requirements, in the current art. It is evident that a need exists for consumer electronic devices to handle both copy-protected and unprotected, clear digital AV content. However, the dual use of digital AV devices for copy-protected and clear content is currently frustrated, to varying degrees, by the installed content protection technology. Copying and transmission to a second device for viewing are now conventionally prevented by default in some digital AV devices unless certain certificates and authentications of license are observed, and this has created inconvenience and difficulty for the user. In some cases it has even been necessary to have duplicate, identical apparatus for clear and protected content. Accordingly, there is need for new content protection technology that will facilitate dual use of copy-protected and clear content on the same apparatus.

### SUMMARY OF INVENTION

This invention provides a controller apparatus and method to store and access, for viewing and/or copying, both copy-protected and clear AV objects on the same consumer electronic device, for example a recorder, player, or server.

The method and apparatus facilitates the storing of both protected and clear data on a single storage device. The method includes partitioning a storage device into clear and protected areas and directing protected data to the protected area and clear data to the clear area.

The apparatus includes storage media for storing digital material such as video, sound, pictures and text. The media is partitioned into protected and unprotected areas. The apparatus further includes circuitry for accessing, decrypting and encrypting data.

### BRIEF DESCRIPTION OF THE FIGURES

In the accompanying drawings:

FIG. 1 is a block diagram view of the content-protection access controller of this invention;

FIG. 2 is a symbolic block diagram showing an HDD and a computation/communication device interconnected via a content-protection access controller, according to the invention;

FIG. 3 is a flow diagram of the operation of the content-protection access controller according to the invention;

FIG. 4 is a symbolic view of a storage device containing both protected and unprotected partitions;

FIG. 5 is a flow diagram showing step 66 of FIG. 3 in greater detail;

FIG. 6 is a symbolic block diagram showing digital AV devices interconnected via a content-protection access controller, to stream video from an HDD to a TV display unit, with user control from a PC;

FIG. 7 is a symbolic block diagram showing digital AV devices interconnected via a content-protection access controller, in a time-shifting configuration.

### DETAILED DESCRIPTION OF THE FIGURES

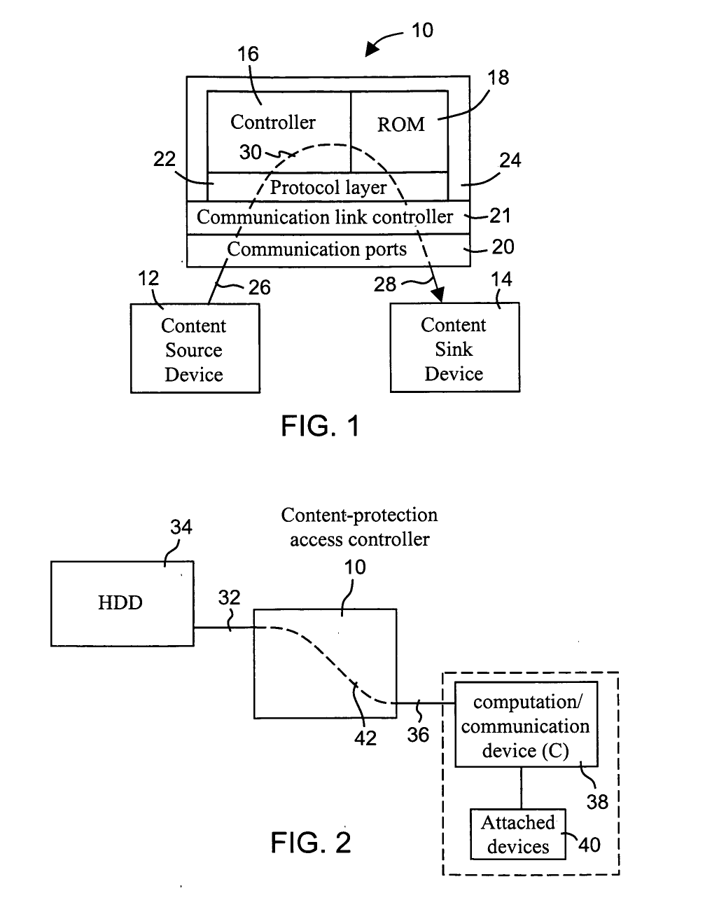

An embodiment of the content-protection access controller 10 of this invention is symbolically shown in FIG. 1, in block diagram form, interposed between content source and sink devices 12 and 14. The content-protection access controller (which will be referred to herein as “access point” for brevity) 10 comprises a digital access controller subsystem 16, which can include random access memory, and which can be in the form of an application specific integrated circuit (ASIC) microchip; a ROM 18 containing operating firmware of the access controller subsystem and other subsystems, and that can be part of the ASIC chip, and alternatively, one or more separate ROM chip(s) associated with respective component parts and subsystems of access point 10 listed and described hereinbelow; communication ports 20 for connection to external devices; a communication link controller circuit 21 that can be a further part of the ASIC chip, and alternatively, a separate link controller chip; a protocol layer 22 that can be a functional subsystem of the access controller subsystem 16; and a printed circuit board (PCB) 24 holding the controller circuits, ROM, and communication ports, along with appropriate support circuits (not shown). Further, the memory component or subsystem of the access point 10 that is herein referred to as ROM 18 can include not only read-only memory, but also a writable nonvolatile memory portion such as flash memory, into which information can be loaded, as will be further described hereinbelow. It will be apparent to those familiar with the art that although the component parts and subsystems 16, 18, 20, 21, 22, 24 of the access point 10 are shown as distinct blocks in FIG. 1, they can be embodied partly in firmware and partly in hardware that can include digital circuits, registers, memory, and other supporting components and circuits that can be shared, and which individually may function in the conventional manner but collectively, according to the invention. The access point 10 is adapted to be externally connected through ports 20 and suitable interconnecting links 26, 28 to end user AV devices 12, 14 (sometimes also referred to as consumer AV devices, electronics, equipment, or apparatus, without restriction regarding home, office, and professional use) that can receive, store, and play digital AV content, using various access protocols, for example AV/C, SBP-2, and HTTP. In the embodiment shown, the IEEE 1394 (referred to herein as “1394”) serial bus known in the art, which has been adopted as the High Definition Audio-Video Network Alliance (HANA) standard connection interface for AV device communication and control, is used for the interconnecting links and corresponding ports. Other known interconnection means including, for example Ethernet, Universal Serial Bus (USB), and 155 Mb/s ATM, can be employed in ports and interconnecting links in alternate embodiments of the invention. As shown in FIG. 1, the signal path between AV content source and sink devices 12 and 14 includes interconnecting links 26 and 28, and a signal path portion 30 symbolically indicated by a dashed curve, inside the access point 10; for convenience, such a signal path will be referred to herein by the reference numeral (in this case 30) of its portion inside the access point. The access point is adapted, in particular, to be interposed in the signal path 30 between AV devices, and it operates by means of appropriate control of the signal path portion 30, to pass or block transmission of AV content between the devices 12 and 14, according to copy protection criteria, as will be described in detail hereinbelow. The action of passing or blocking AV content transmission between AV devices is referred to herein as “access control”, and it should be further noted that the terms “pass” and “block” are used herein in a functional sense of a clear, decrypted, or appropriately re-encrypted form of an AV content signal received from source device 12 being made available, and not available, respectively, to a sink device 14. Accordingly, when the content transmission is blocked, it is not necessary to physically prevent signal transmission, and an unintelligible bit stream can be present. In an alternate embodiment, access control may be implemented by physically switching signal transmission on and off by means of suitable circuit elements.

Access point 10 is adapted in this embodiment to operate in conformance with the IEC 61883 standard. Common types of AV content source devices 12 and content sink devices 14 that can be connected to, and access-controlled, by access point 10 are listed in Table 2 (below), as examples, not meant to be limiting or exhaustive; and the DRM and content protection requirements of the objects that these devices are typically expected to handle are indicated in the last two columns.

TABLE 2

| Type | | | AV device | Protected | Clear |
|---|---|---|---|---|---|
| Content source | (A) | Receiving and | Set-top box | | |
| device 12 | | media reading | Wireless receiver | | |
| | | devices | TV receiver/demodulator | | |
| | | | Optical media player | | |
| | | | Game box | | |
| | (B) | User content | Camcorder | | |
| | | production | Video camera | | |
| | | devices | Microphone | | |
| Content | (C) | Computation | Modem | | |
| source | | and | PC | | |
| device 12 | | communication | Portable personal device | | |
| or | | devices | | | |
| sink device 14 | (D) | Storage devices | HDD | | |
| | | | DVD-DVR | | |
| | | | Flash drive | | |
| | | | Tape drive | | |
| Content | (E) | Video and | TV display, monitor | | |
| sink | | audio playback devices | Sound (audio) system | | |
| device 14 | | | | | |

As shown in Table 2, source devices 12 can generally comprise four main types: receiving and media reading devices (A) such as a set-top box, satellite receiver, or TV receiver or demodulator, performing functions such as demodulation of the carrier, data conversion, authentication, and decryption as known in the art, that deliver commercially supplied content as a serial bit stream of AV data from a commercial distribution channel, and devices that read a bit stream from physically delivered prerecorded media, such as a DVD, CD, game disk or card; user content production devices (B) such as a digital video camera, camcorder, or a microphone, that are generally used with clear content; computation and communication devices (C) such as a computer, PC, a modem connected to the internet, a portable personal device with two-way wireless network connectivity and computation capability, that can receive, and read (play back) from included or attached memory, any type of previously stored and modified content, both commercially supplied and user-produced; and storage devices (D) such as an HDD, DVD-VDR, flash drive, memory card recorder, tape drive, and other media storage device, using various storage media such as magnetic, optical, semiconductor memory, and nanostructure media, which can be employed to read (play back) any type of previously stored content.

Sink devices 14 can generally comprise video and audio playback devices (E) such as a TV display, PC monitor, stereo (audio) sound system, and virtual reality device, used to reproduce (play, display) serial AV data as visual images, sound, and force patterns; computation and communication devices (C); and storage devices (D). The purpose of storing commercially supplied content may be for archival storage of a backup copy and for temporary storage (time shifting) of an AV entertainment object for user convenience. It should be noted that devices (C) and (D) can be a source device 12 or a sink device 14, according to the application.

It should be apparent to those familiar with the art that in a typical home or other end user installation, several of the AV devices described hereinabove can be connected together and used in combination; and that the devices may be packaged as stand-alone devices, or in the form of subsystem units of a composite AV device, as, for example, in a conventional high-end digital TV system that can have several built-in capabilities for signal reception, decoding, storage, playing of prerecorded media, and viewing. The access point is adapted to be connected at the factory to a digital AV device, that can be a content sink device, and alternatively, a content source device, and it is anticipated that the access point will be packaged in the majority of its applications as a subsystem unit inside the enclosure of the AV device, without, however, excluding other forms of connection, packaging and application that may be found useful. It should be further apparent that interconnection, both internally at the factory and externally at a user installation, can be by 1394 bus. An AV device can have a multiplicity of 1394 ports, typically up to three, for interconnection with other AV devices. The access point 10 in this embodiment of the invention has four 1394 ports and four corresponding interconnecting links, comprising two signal transmission paths (between two pairs of AV devices), that can be concurrently operated, although only two of the links (26, 28) are shown in FIG. 1. Further, in alternate embodiments there can be more than four such ports and interconnecting links, and a greater number of signal transmission paths that can be concurrently operated, with appropriate modifications made to the device. As known in the art, every device connected by the 1394 bus has a configuration ROM which holds its unique ID, and, in the case of digital consumer AV devices, other device certificate information issued by the Digital Transmission Licensing Authority (DTLA) at time of manufacture of the device.

According to the invention, device certificate information, such as DTCP authentication and content channel keys, for AV devices connected to the access point at the factory, and alternatively also for AV devices intended to be connected subsequently for system installation by a user, can be conveniently loaded into access point 10 from a flash memory device temporarily connected for this purpose to a communication port 20, by the manufacturer or system supplier, and can be stored in the access point, for example in its ROM 18. Further, the configuration ROMs of the connected devices can be included as firmware portions in ROM 18, or alternatively they can be implemented as separate ROM chips on PCB 24. In still an alternate embodiment, the access point 10 can also receive and store device drivers and formatting information in like manner. Such loading and storing can be performed, for example, with the aid of a secure software program and editing interface on a computer temporarily connected to another port of the access point, at the factory.

PCs and general-purpose digital storage devices used with computers may not have a device certificate and, accordingly, would not be authorized to receive protected content, but they can nevertheless be connected to other digital AV devices and to the access point 10. Thus access control of a PC can be an important use of access point 10, and can serve as a first example, to describe its operation according to the invention.

As known in the art, every device is identified and its configuration ROM is viewable by other devices on the bus, and control signals can be passed between them. Basic bus arbitration operation occurs at power up, after which the device IDs and certificate information of the devices connected to access point 10 can be retrieved from the respective device configuration ROMs for subsequent use by the access point, if not previously loaded and already stored in the access point. It is important to note, however, that access point 10 does not follow conventional 1394 communication link behavior of unconditionally passing signals and data to other connected devices. The circuits and firmware performing the interconnecting link and bus related operations of access point 10 are symbolically shown as communication ports 20 and communication link controller 21 in FIG. 1.

Operation of the access point 10 will be described with reference to several examples, each of which shows a portion of an example home AV system. In each example, the access point is connected by 1394 bus interconnecting links to digital AV source and sink devices, such as described hereinabove with reference to Table 2, and controls access by sink devices to AV content available from a source device. In the description of the operation given hereinbelow, described actions will generally be assumed to be performed by the access point 10, by means of appropriate circuits and firmware instructions contained therein, and in its component parts and subsystems shown in FIG. 1, unless clearly apparent or noted otherwise.

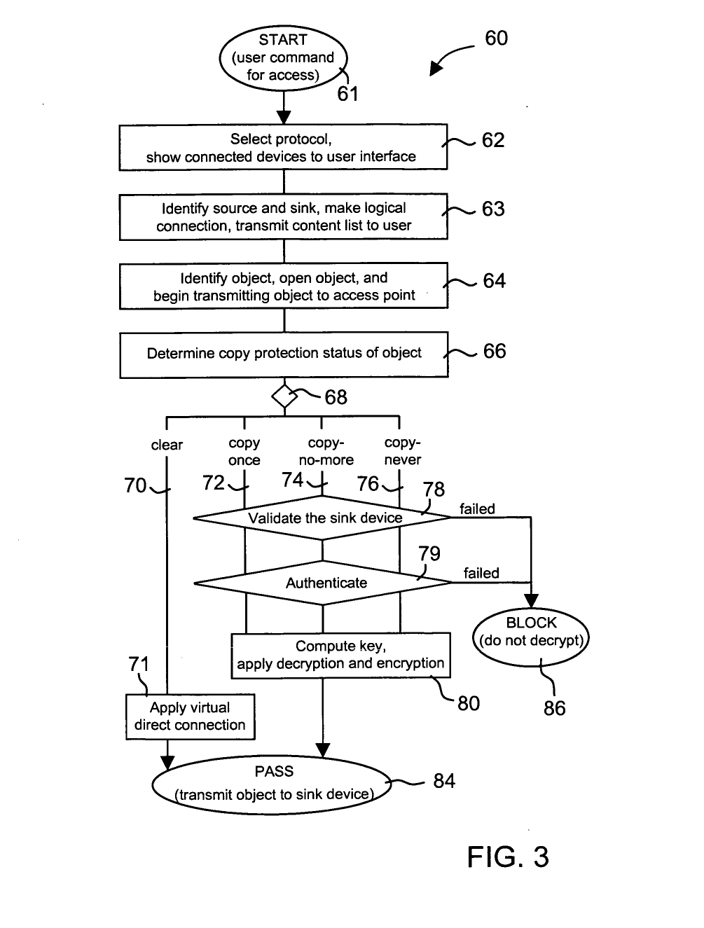

The first example, Type (B) device, from Table 2 describes operation of the access point 10 to control access by an uncertified computation and communication device to a user-produced clear AV object on an HDD, for viewing and editing the object, wherein the HDD contains both a clear and a protected partition. In this example, access point 10 is connected as shown in FIG. 2 by interconnecting link 32 to an HDD 34, and by link 36 to a computation and communication device 38 of type (C) described hereinabove with reference to Table 2, that can be, for example, a PC or other type of computer, and which can be typically connected to further attached devices 40. Operation of access point 10, according to the method of the invention, may be described by a sequence 60 of steps shown in FIG. 3, in flow diagram form. In the first (START) step 61 of operation, a user command for access by device 38 is received over interconnecting link 36 from a user interface outside the access point. The user interface can generally be a user program on any connected device which can interact with the access point using control commands transmitted over the interconnecting link, as will be described hereinbelow with reference to other examples of operation. The access point 10 is adapted according to the invention to use high-level communication protocols which are known in the art—including AV/C, SBP-2, SBP-3, RBC, and HTTP over TCP/IP—and which are selected to be employed in a particular access control operation according to the sink and source devices being access-controlled, the AV content object type, and the user interface. The circuits and firmware performing high-level protocol-related operations of the access point 10 are symbolically shown as protocol layer 22 in FIG. 1. In the present example, the user interface can be a known browser program on device 38, which can interact with a web server program on access point 10 that can be included, for example, in the firmware on ROM 18. Accordingly, in the second step 62 of operation (in response to the user command for access from device 38), the HTTP control protocol is selected for interaction with the user interface, and basic information about connected devices can be transmitted to the user interface. In the third step 63 of operation, device 38 can be identified as the sink device, in response to selection by the user, and alternatively, the sink device can be identified by default to be the device where the user access command of step 61 originates (in the present example, device 38). Further in step 63, HDD 34 can be identified as the source device, in response to selection by the user. Device certificate information can be retrieved if not previously provided. Appropriate protocols—in this case, AV/C disc subunits—can be selected for control communication between access point 10 and source device HDD 34. A logical connection between source and sink devices can be made, identifying a signal path 42, including links 32, 36, and a portion 42 inside the access point 10, which are shown in FIG. 2. The storage space and file system attributes, including directory information of a connected storage device, which in an alternate example AV system can be another device of type (D) described with reference to Table 2, can be examined by the access point, and a content list (track list, set of icons) of the stored objects can be made available to the user program, without giving access to the objects themselves; in the current example, the content list of stored objects on HDD 34 is made available.

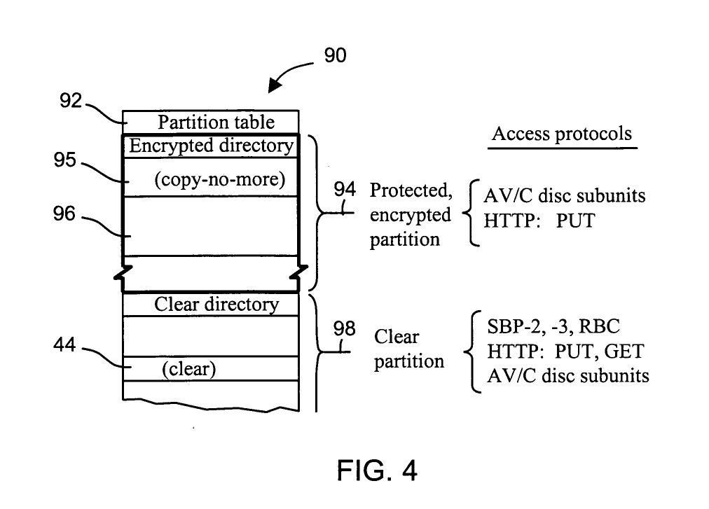

An example of the data storage space 90 of HDD 34 is illustrated schematically in FIG. 4, showing a partition table 92, which maps a protected partition 94 including protected objects 95 and 96, and a clear partition 98 that can contain unprotected, clear AV content data, including in this example, the desired AV object 44. The copy protection status of objects 44 and 95 is indicated in parentheses. Protected objects are encrypted and further protected as described hereinbelow by use of a custom, nonstandard file system and an encrypted directory in the protected partition. Although one protected and one clear partition are shown in the example in FIG. 4, the storage space 90 can have further partitions, both clear and protected, as may be convenient in an application. Characteristics of the storage space, and the access protocols to the objects stored therein, which are shown in FIG. 4, will be described in further detail hereinbelow, with reference to particular examples of content and operation.

In the fourth step 64, the desired AV content object 44, located on the clear partition 98, is identified in response to a user selection from the content list of HDD 34, which was made available to the user program. The object 44 can be opened, for example, with the HTTP: GET command from device 38 applied over link 36 to access point 10, and translated to AV/C disc subunit commands applied over link 32 to HDD 34, to begin reading and transmitting the content bit stream to access point 10. The object 44 can be, for example, an AV clip in the known HDV or DV format, based on a family event recorded by a video camera and a microphone which has been edited and augmented with computer-generated images, music, special effects, and text, with the help of suitable programs, on a PC. The object 44 is assumed to have no DRM issues and therefore to have “clear”, also known as “copy-free”, copy protection status according to the DTCP specification, which allows unrestricted use. It may be noted that the DTCP specification currently recognizes one clear and three restricted protection levels—“copy once”, “copy-no-more”, and “copy-never”, and that the last and most restrictive protection status may specify a limited retention time for the received content, from zero to a week, after which the content should become unusable.

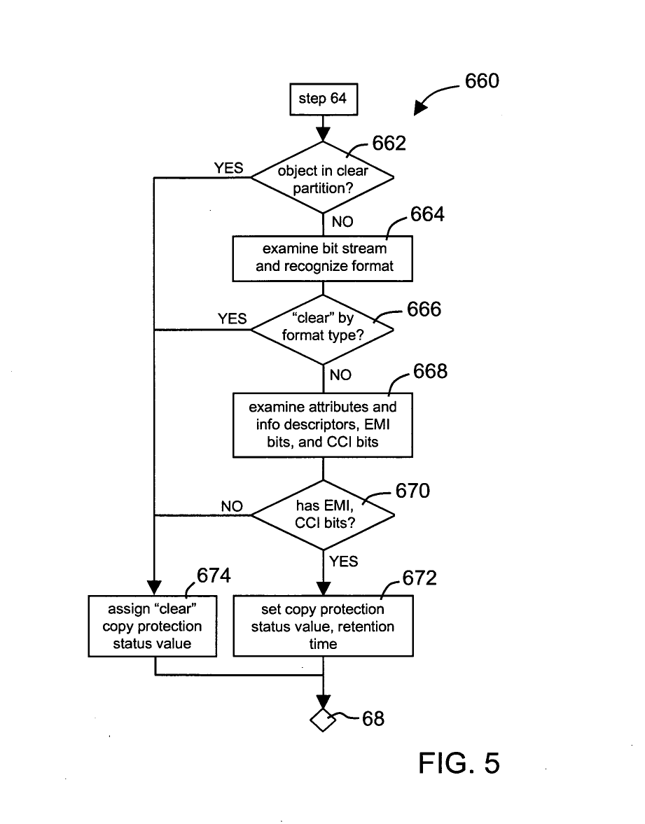

In the fifth step 66 of operation, which is depicted in further detail in FIG. 5 as a sequence of sub-steps 660, access point 10 can determine the copy protection status of an AV object. Whether or not the object is located on a clear partition is checked in the first sub-step 662. In the present example, the desired object 44 is located on a clear partition of a storage device, as noted hereinabove, and it can be considered to have “clear” status already by its location; thus operation can jump to sub-step 676, wherein a clear status is assigned, and then continue to step 68. Although other sub-steps of the sequence 660 are in this case bypassed, these will also be described here for clarity. In general, access point 10 can determine the copy protection status of an AV object by examining the content bit stream and recognizing the format and the object type in sub-step 664. Digital AV object types generally comprise video, music, and pictures, which can have various formats, including HDV, DV, MPEG-2, H.264, and MPEG-4 which are commonly used for video (transport and compression). DV, for example, is a digital videotape format utilized in user content production devices of the type (B) identified hereinabove in Table 2, and generally not for commercially distributed content; thus an object recognized to be in DV format can be presumed to have no DRM requirement, and accordingly will have “clear” status by format (object) type determined in sub-step 666, and operation will proceed along the YES branch to sub-step 674 and thence to step 68. If the format does not imply a clear object, copy protection status can be determined in sub-step 668, as known in the art, by examining the attributes and info descriptors for the bit stream; and reading the Encryption Mode Indicator (EMI) value from the packet headers; and for further confirmation, also reading the Content Control Indicator (CCI) bits periodically embedded in the content stream. If no EMI or CCI bits are found, operation can proceed along the NO branch of sub-step 670 to assign clear status to the object in sub-step 674. If an EMI value confirmed by CCI value, or only a CCI value, is determined from the content bit stream of the object, and indicates a copy-protected status, operation continues along the YES branch of sub-step 670. The appropriate copy protection status value (and for “copy-never”, also the retention time) is set (registered) in access point 10, and operation continues to step 68. Although the sub-steps 668, 670, 672 refer to EMI and CCI bits defined for AV objects employing video formats, it will be apparent to those familiar with the art that said sub-steps can be appropriately modified to adapt the access point 10 to determine content protection status and provide access control also for music and picture objects according to different formats and DRM systems, in substantially similar manner. For digital music and pictures, various DRM systems are used in the art by major commercial distributors, for example Apple, Inc., Microsoft Corporation, and the Open Mobile Alliance (OMA). Digital music formats include, for example, MP3, WMA, Ogg, and AAC, and commonly used formats for (still) pictures and graphics include, for example, JPEG, TIFF, RAW, PNG, GIF, AutoCAD DWG, which the access point can be adapted to recognize. A third protocol selection can be made (after sub-step 664) according to the format of the object, for control communication with a storage device over link 32 and data transmission over the signal path 42, while continuing to use HTTP for user communication from device 38. For example, in an alternate AV system, wherein the content source device is a VDR storing clear content received from a camcorder, and the sink device 38 is a random access (non-linear) editing PC, the SBP-2 or SBP-3 protocol can be used in place of AV/C for faster data transmission.

In the sixth step 68 of operation, shown in FIG. 3, a branch decision is made, based on the copy protection status determined in previous step 66. For clear status, as in the current example, operation jumps to branch 70 wherein a virtual direct bus connection is applied between interconnecting links 32 and 36 in step 71, thereby mounting the clear partition 98 on device 38, and thus effectively passing transmission of the content bit stream of clear AV object 44, from a clear, unprotected partition 98 on source device HDD 34 (which also contains a protected partition 94) to uncertified sink device 38, as symbolically indicated by end step 84. Accordingly, the clear partition 98 can be mounted by a computation device 38 and its clear file directory can be read and files accessed in the conventional manner by the device. A suitable known file system, for example NTFS, can be employed in the clear partition.

Access by an uncertified sink device 38 to the protected partition 94 can be prevented, according to the invention, by four levels of protection. First, a custom, nonstandard proprietary file system, which is not in common use, and cannot be mounted by, and is not accessible by conventional operating systems, can be used in the protected partition. It will be apparent to those familiar with the art, that a custom file system for a storage device can be adapted to differ from standard, conventional file systems such as NTFS, FAT32, HFS, UFS, UDF, YAFFS, i.e., customized, in a great many ways, for the purpose of rendering the file system and data structures un-mountable and unrecognizable by a conventional computer operating system, for example, by using a different block size, or a different directory layout in terms of address bit positions; and in alternate embodiments of the invention, any of such customizations may be employed for the purpose. Second, the directory of the protected partition 94 can be encrypted. Third, the data files can be encrypted in the protected partition. It should be noted that the second and third levels also protect against access to the protected partition by a direct connection bypassing the access point. Fourth, when a computer, and alternatively another suitable device of type (C) as described hereinabove, is employed as the user interface for access to the storage device, the choice of control communication protocol between the access point and the user interface program on the computer can be restricted to HTTP over TCP/IP, and the “GET” command can be disabled for the protected partition when the sink device is also a device of type (C), thereby providing a further (fourth) level of protection against access by an uncertified (unauthorized) sink device.

The second example, Type (C) device, from Table 2 describes operation of the access point to block access by an uncertified device to protected content on a storage device. The operation sequence described hereinabove, and shown in FIG. 3, will terminate in the other end step 86 shown if the protection status is not “clear” and either validation step 78 or authentication step 79 fail. In a second example of operation, with the same source and sink devices HDD 34 and device 38 as in the first example described hereinabove, if the user command is to transmit object 95 with “copy-no-more” protection status, shown in FIG. 4, the operation will branch in step 68 along branch 74 to step 78, wherein the existence of a device certificate is checked for sink device 38, as a preliminary validation step before authentication in step 79 according to DTCP specification. Preliminary validation is a timesaving feature whereby transmission of protected content to uncertified devices can be quickly blocked before proceeding with the authentication procedure. In this example, it is assumed that sink device 38 does not have a device certificate issued by DTLA, consequently validation step 78 fails, and operation branches to end step 86, wherein the access point 10 operates to block transmission of protected content 95 (from a protected partition 94 of storage device HDD 34, which also contains an unprotected partition 98) over signal path 42. As noted hereinabove, it is not necessary to physically prevent signal transmission, and transmission of protected content can be blocked in this embodiment by not decrypting the transmitted signal and thus leaving it unintelligible and not viewable by the sink device.

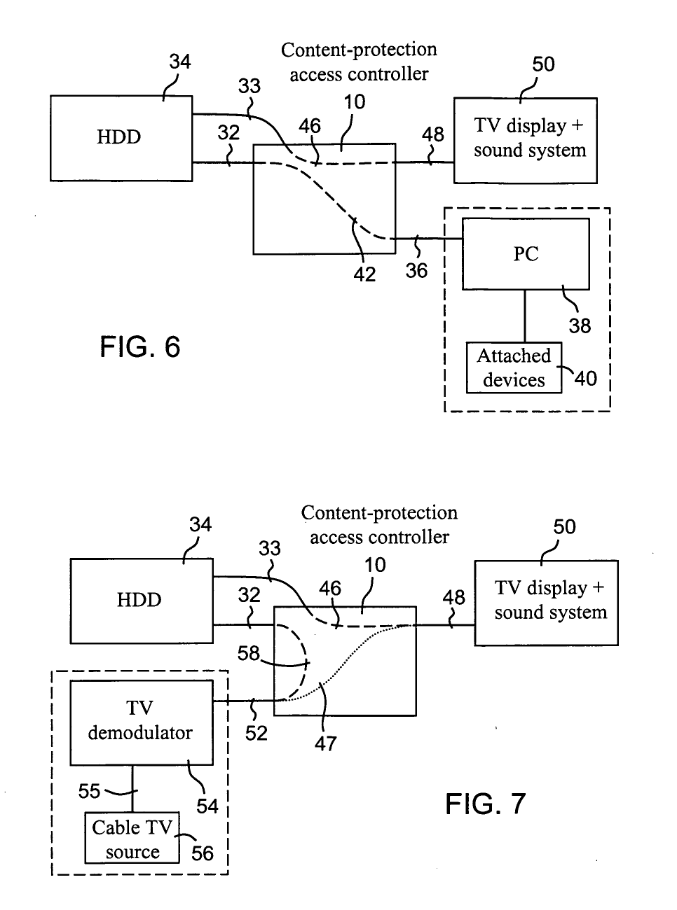

The third example, type (D) and (E) devices, from Table 2 describes operation of the access point to stream video from an HDD to a TV display unit, with user control from a PC. In this example of operation, according to the sequence 60 of steps shown in FIG. 3, access point 10 can be connected, as shown in FIG. 6, by two interconnecting links 32, 33 to HDD 34, also by interconnecting link 48 to TV display and sound system (display unit) 50, and by interconnecting link 36 to PC 38, in order to enable PC 38 to control streaming of video from HDD 34 to display unit 50. In the present example, PC 38 is not a sink or source device, but acts only as a user interface for control communication over link 36, the sink device being display unit 50, and the source device, HDD 34. It will be apparent to those skilled in the art that in an alternate embodiment, the user interface can be on TV display unit 50, with control commands transmitted over link 48, and still alternatively, user commands can be issued via an infrared remote control unit. In yet an alternative embodiment, portions of a user interface can be included in the access point 10, with appropriate circuit modification. If will be further apparent that a wireless connection can be used to implement the interconnecting link 36, with appropriate modifications made to the communication ports 20, to the communication link layer 21, and to related portions of the access point 10. Such a wireless connection can enable another suitable device of type (C), for example a computation- and communication-capable portable personal device, such as a cell phone, iPhone™, Blackberry™, or a wireless remote control unit, with a suitable user (software or firmware) program, to be employed in place of the PC as a user interface, with equal effect. Further, in an alternate AV system application, the wireless connection can be adapted to be employed also for content transmission over link 36, as described hereinabove with reference to the first example of operation.

Operation in the present (third) example starts, in step 61, by a user command for general access, issued from the user interface on PC 38. Reference is made also to the first example of operation given hereinabove, for description of some of the steps that are similar. In the second step 62 of operation, the HTTP control protocol is selected for interaction with the user interface over link 36, and connected device information can be transmitted to the user. In the present example, the user interface is a browser program on PC 38, which interacts with a web server program resident in access point 10. In the third step 63 of operation, in response to selection by the user, TV display unit 50 can be identified as the sink device, HDD 34 can be identified as the source device, and device certificate information can be retrieved, if not previously provided. The AV/C protocol can be selected for control communication between access point 10 and display unit 50, and the disc subunits of AV/C, in particular, can be selected for communication between access point 10 and HDD 34. A logical connection between source and sink devices can be made for data streaming, identifying a signal path 46, including links 33, 48, and a portion 46 inside the access point 10, as shown in FIG. 6. The file system attributes and directory information of HDD 34 can be examined by the access point, and a content list of stored objects can be made available to the user program.

It will be assumed in this example that the object to be streamed (transmitted) is an AV object 95, as shown in FIG. 4, which is stored on a protected partition 94 of HDD 34 in a known format such as MPEG-2, and which has a “copy-no-more” protection status specified by attributes and information descriptors, EMI bits, and by CCI bits embedded in the data. In the fourth step 64, the desired object 95 is identified in response to user selection from the content list, its location as noted hereinabove is determined, and the object 95 can be opened, to begin reading and transmitting the content bit stream to access point 10, using AV/C protocol.

In the fifth step 66 of operation, which is depicted in further detail in FIG. 5, operation passes through branch sub-step 662 along the NO branch, to sub-step 664, wherein the bit stream is examined and the format recognized, then through branch sub-step 666 along the NO branch to sub-step 668 wherein the bit stream attributes and info descriptors are examined, the EMI bits are read, and also the CCI bits are read for confirmation. Operation then passes through sub-step 670 along the YES branch to sub-step 672 wherein the “copy-no-more” protection status is set for the content stream.

In the next step 68 of operation, a branch decision is made and operation proceeds along the “copy-no-more” branch 74 shown in FIG. 3. It is assumed in this example that the sink device (display unit 50) has a device certificate and is validated in step 78 (described hereinabove), and operation continues to step 79, wherein authentication is performed by access point 10 between the source and sink devices according to DTCP specification, as known in the art. Generally, operation then branches to step 80 or step 86, according to successful or failed authentication, respectively. It may be noted that in the “copy once” and “copy-no-more” branches 72, 74, authentication according to DTCP specification, as known in the art, can be either full, or else restricted if sufficient device certificate information for full authentication is not available in the access point or retrieved from the configuration ROM of a device; and in the “copy-never” branch 76, full authentication is required. It is assumed in this example that authentication is successful and operation continues to step 80, wherein the decryption key is computed and applied to the content bit stream transmitted from link 33, as known in the art, and accordingly, a decrypted bit stream is transmitted (streamed, passed) to display unit 50, in step 84 of operation. It should be understood that only clear, unencrypted content can be viewed on a display unit. The access point 10 in this example thus operates to stream protected AV content from a protected partition 94 of a storage device HDD 34, to a display unit 50 for viewing, under user control from a PC 38.

The fourth example, of type (A) (D) and (E) devices, from Table 2 describes operation of the access point for viewing, recording, and time-shifting a copy-protected AV content bit stream, such as a cable-TV broadcast movie. In this example, access point 10 can be connected in a time shifting configuration, as shown in FIG. 7, by two interconnecting links 32 and 33 to HDD 34, also by link 48 to TV display unit 50, and by link 52 to TV demodulator 54, which receives input from a commercial digital cable TV source 56 (over coaxial cable connection 55). The user interface can be a remote control unit operating with the display unit 50, and alternatively, other user interfaces may be employed as described hereinabove. In this example, with reference also to FIGS. 3-5, operation can start in step 61 with a user command to view (play) a particular cable channel from TV demodulator 54 on TV display unit 50, and in order to enable time-shifting, it is also automatically a command to record (store) the content on HDD 34 during viewing. The desired AV object can be, for example, a movie currently showing on the particular cable channel, with “copy-never” protection status and retention time of one day. It will be observed that two user view commands, live and timeshifted, can be defined in a system with timeshifting capability, wherein live view is typically (and in a first embodiment) implemented by viewing the recorded content immediately after recording, and timeshifted view, by viewing recorded content from an earlier time point, for example, from the beginning of a pause of live viewing. For both commands, it is a dual operation, involving two signal transmission paths through the access point, 58 for recording and, in a first embodiment, 46 for viewing, shown in FIG. 7. Operation of the access point 10 according to the sequence 60 of steps shown in FIG. 3 will be described concurrently (in parallel) for both paths, a step at a time.

In the second step 62 of operation, the AV/C control protocol, and alternatively CEA 931A/B, can be selected for interaction with the user interface over link 48, and connected device information can be transmitted to the user. In the current example, default source and sink devices can be implied in the user commands, requiring no user selection of source or sink devices in the next step of operation. In this case, the device information that is transmitted to the user interface may be limited to interconnection and power status. Accordingly, in the third step 63 of operation, HDD 34 can be identified as the sink device, and TV demodulator 54 as the source device in the recording signal path 58; and TV display unit 50 can be identified as the sink device, and HDD 34 as the source device in the viewing signal path 46, in response to the user commands issued in step 61, which can include also the particular channel number desired. Device certificate information can be retrieved if not previously provided. The AV/C protocol can be selected for control communication between access point 10 and display unit 50, and the disc subunits of AV/C can be selected for communication between access point 10 and HDD 34. Logical connections between source and sink devices can be made in the two signal paths 58 and 46, wherein path 58 includes links 52, 32, and a portion 58 inside the access point 10, and path 46 includes links 33, 48, and a portion 46 inside the access point 10, as shown in FIG. 7. The file system attributes and directory information of HDD 34 (which is a content sink device in path 58 and a content source device in path 46) can be examined by the access point. HDD 34 can have a storage space 90 as shown in FIG. 4 and described hereinabove, including both a clear partition 98 and a protected partition 94. An empty file location 96 in the protected partition can be designated as the content sink file for storing copy-protected content; and a suitable file location in the clear partition can be designated for storing clear content. The final selection for storing will be made at a later step of the operation sequence, after determining the copy protection status, as will be presently described hereinbelow.

According to the invention, the access point 10 can format (and reformat) a storage device to which it is connected, for example, at the factory or service shop; this can be performed using suitable firmware provided in ROM 18 and previously loaded device information, and alternatively, formatting can be performed through a temporary second connection to a computer with a user interface and suitable formatting software. In particular, a data storage space with both clear and protected partitions can be set up (installed, formatted) on the storage device HDD 34 if not previously set up. As described hereinabove, a suitable known file system, for example NTFS, can be employed in the clear partition; and in alternate embodiments, there can be more than one clear partition, each with a different, known (industry-standard) file system such as HFS, FAT32, UFS. In the protected partition 94, a custom, proprietary file system can be used, which cannot be mounted by conventional computer operating systems, as described hereinabove (with reference to the first example of operation).

For the recording signal path 58, an active channel list is generally available from TV demodulator 54 over link 52 and can be transmitted to the user interface in step 63, for selection of the desired channel (AV object) by the user, but this is not required in the current example, as a particular channel was already specified in the first user command given in start step 61. Accordingly, the desired AV object is identified and can be opened in step 64 by suitable control signals between access point 10 and TV demodulator 54, for example, using AV/C protocol, to begin transmitting the content bit stream of the channel to access point 10, on interconnecting link 52. In the viewing signal path 46, the desired AV object for live viewing is the file recorded on HDD 34 over signal path 58, at an address (time point) slightly behind (delayed from) the storing address (time point). Accordingly, in this embodiment, opening and beginning to transmit the object to display unit 50 (i.e., performance of step 64) will be delayed in signal path 46 until a stored object becomes available in step 84 of operation in signal path 58.

In the fifth step 66 of operation, which is depicted in further detail in FIG. 5, operation in signal path 58 passes through branch sub-step 662 along the NO branch, to sub-step 664, wherein the bit stream is examined and the format recognized, then through branch sub-step 666 along the NO branch to sub-step 668 wherein the bit stream attributes and info descriptors are examined, the EMI bits are read, and also the CCI bits are read for confirmation. Operation then passes through sub-step 670 along the YES branch to sub-step 672 wherein the “copy-never” protection status is set for the content stream, and the designated file 96 in the protected partition is selected for recording. In the next step 68, operation branches along the “copy-never” branch 76, source and sink devices are assumed to have device certificates and are validated in step 78 (described hereinabove), and operation continues to step 79, wherein authentication is performed by access point 10 between source and sink devices according to DTCP specification, as known in the art. It is assumed, for purposes of this example, that authentication is successful between the content source and sink devices, and operation continues to step 80, wherein the decryption key is computed and applied to the incoming content bit stream from link 52, as known in the art. Further, as the sink device is identified as a storage device, an encryption key for HDD 34 is computed, and the content bit stream is encrypted again. As a live view command is active, the retention time changed to zero, and operation then continues to end step 84, wherein encrypted content data is transmitted to HDD 34 and stored (recorded) in file 96 in the protected partition 94 as designated in step 63. Generally, in the art, the retention time of a portion of “copy-never” content which is being viewed is set to zero, when it is also transmitted for recording to another device to prevent a second viewing. It should be understood that zero retention time allows reading a stored “copy-never” slightly after storing, to implement a live view user command. Following this, operation of step 64 in signal path 46 can continue, as described hereinabove, and proceeds to step 80 wherein the content from file 96 on HDD 34 is suitably decrypted again and operation further continues to end step 84, wherein the decrypted content bit stream from file 96 is transmitted to display unit 50 for viewing. Thus, during live viewing of the movie, the access point 10 operates in step 84 to pass transmission of the content bit stream over signal path 58 from TV demodulator 54 in re-encrypted form, with the same “copy-never” protection status and retention time changed to zero, to be stored in file 96 of the protected partition 94 on HDD 34; and to pass transmission of the same content over signal path 46 in decrypted form from HDD 34 (from a read address slightly behind the store address) to display unit 50.

Now, when the user pauses live viewing, as for example to answer the door, the freeze frame address (of the current frame being recorded in file 96 at pause time) is registered, reading of content from HDD 34 is stopped (and a freeze frame can be transmitted to display unit 50 over signal path 46), but transmission of the incoming content stream to be stored on HDD 34 over signal path 58 continues, with the exception that the retention time of the content being stored is not changed to zero but stays at the original one-day value (because this portion of the incoming content stream is not being viewed). When the user resumes viewing by issuing a timeshifted view command, the desired AV object for viewing is still the file 96 on HDD 34, but now the starting point for reading and transmitting the content for viewing, in path 46, is determined to be the freeze frame address registered at pause time (which is an earlier time point depending on the pause interval). In other respects, operation continues as described hereinabove for the live view user command.

The user may revert back to live viewing (without timeshifting) by issuing a live view command during a program interruption such as a commercial break that exceeds the pause interval, which restores the read address in path 46 to be slightly behind (delayed from) the storing address (time point) used in path 58, and access point 10 operates in all respects again as described hereinabove for live viewing.

In an alternate “direct live” embodiment of the invention, in the current (fourth) example of operation, live viewing can be implemented by forming a direct signal path 47 between the incoming content source (TV demodulator 54) and display unit 50, without going through HDD 34. This viewing signal path 47 includes links 52, 48, and a portion 47 inside access point 10 as shown in FIG. 7. In this signal path, TV demodulator 54 is the source device, and identification and opening of the desired AV object can be shared in step 64 of operation with the recording signal path 58, as both signal paths 47 and 58 have the same source device. If the user pauses live viewing in this embodiment, transmission can be stopped in signal path 47, and a freeze frame address can be registered as described hereinabove for the first embodiment. When the user resumes watching the movie by issuing a timeshifted view command, a different viewing signal path 46 can be formed, wherein HDD 34 is identified as the source device in step 63 of operation, and operation continues substantially as described hereinabove for timeshifted viewing in the first embodiment.

In the present example of operation, the incoming bit stream of the channel can be “copy-never” during the movie, and it can change to a different protection status, for example, “clear” during a program interval when the AV content is a commercial (advertisement) or other type of unrestricted material. The attributes and information descriptors, EMI bits, embedded CCI bits, and encryption of the content bit stream can be dynamically switched at appropriate times by an originating cable TV source 56, when the content switches between the movie and a commercial. A change of protection status to “clear” content will be detected in step 66 and the clear partition would be selected for storage, as described hereinabove; however, it can be advantageous to store temporary portions of clear content, which are embedded in a protected AV content stream, in the same file as the protected content, in the protected partition of the storage device, in order to reduce any delay time that may be associated with changing partitions and file addresses during a movie that contains advertisements. Access point 10 can be adapted according to the invention to delay a change of storage location. For example, clear content can continue to be stored for a limited time in file 96 in the protected partition in sequence with portions of the movie, but when the content bit stream stays clear beyond a predetermined time, the storage location can be changed to the file designated (in step 63) in the clear partition 98.

When the operation of access point 10, according to the sequence 60 of steps shown in FIG. 3 and described hereinabove, terminates in end step 84, transmission of the AV content bit stream, according to a user command, can continue until a new user command is received, or a reset or interruption event occurs. Thus, a start step 61 shown in FIG. 3 can represent not only a user command but an automatic restart. Reset and interruption events that can automatically restart operation of the access point, from step 61, can comprise for example, power loss, hardware failure, mechanical disconnection, interruption and excessive noise in an incoming content bit stream, and reception of a copy protection challenge code in the content bit stream. Such restart can employ the prior user-command parameters last received by the access point from step 61 before the reset or interruption event.

In an alternate embodiment, the access point can accommodate a further protection status value—“copy n-times”—by appropriate modification of the firmware, wherein an initial value of n specified for the content can be decremented appropriately upon each copy event, until the current value becomes 0, which will be equivalent to “copy-no-more”, and operation with values of n equal to 1 and greater can be performed as described hereinabove for “copy once.” The value of n can be an integer, for example, 9.

Various modifications may be made to the invention without altering its value or scope. For example, while this invention has been described herein using the example of access point 10, many or all of the inventive aspects are readily adaptable to other AV designs, other sorts of entertainment equipment, and the like.

It is expected that there will be a great many applications for these which have not yet been envisioned. Indeed, it is one of the advantages of the present invention that the inventive method and apparatus may be adapted to a great variety of uses.

All of the above are only some of the examples of available embodiments of the present invention. Those skilled in the art will readily observe that numerous other modifications and alterations may be made without departing from the spirit and scope of the invention. Accordingly, the disclosure herein is not intended as limiting and the appended claims are to be interpreted as encompassing the entire scope of the invention.

It is anticipated that the access point will have wide use in a multiplicity of consumer and professional electronic systems, including, for example, set top boxes, media server computers, HDD and DVD recorders, displays (monitors) of Personal Computers, TV sets, home music systems, portable music recorders and players, and personal communication devices.

### INDUSTRIAL APPLICABILITY

The inventive apparatus and method are intended to be widely used in a great variety of electronic applications. It is expected that they will be particularly useful in consumer electronic applications where significant storage capacity and speed is required.

It is anticipated that the content-protection access controller will have wide use in a multiplicity of consumer and professional electronic systems, including, for example, set top boxes, media server computers, HDD and DVD recorders, displays (monitors) of Personal Computers, TV sets, home music systems, portable music recorders and players, and personal communication devices.

Since the inventive storage system and method of the present invention may be readily produced and integrated with existing tasks, input/output devices and the like, and since the advantages as described herein are provided, it is expected that they will be readily accepted in the industry. For these and other reasons, it is expected that the utility and industrial applicability of the invention will be both significant in scope and long-lasting in duration.

1. A device for controlling access to data comprising a shared storage device for storing and reading copy-protected and clear AV content objects, as determined by the content protection status of the object, wherein said shared storage device has at least one clear partition and at least one protected partition.

2. A device for controlling access to data as in claim 1, further comprising an encryptor for encrypting the directory of said protected partition.

3. A device for controlling access to data as in claim 2, wherein said protected partition has a custom file system that is not accessible by conventional operating systems.

4. A device for controlling access to data as in claim 3, wherein the data on said protected partition is encrypted.

5. A device for controlling access to data as in claim 4, further comprising a device for generating a GET instruction wherein said GET instruction is disabled if the device does not receive a proper permission for retrieving said protected data.

6. A device for controlling access to data as in claim 1, wherein said clear partition has a conventional file system.

7. A device for controlling access to data as in claim 6, wherein access to a clear object is provided by virtual direct bus connection between a content source device and the shared storage device.

8. A device for controlling access to data as in claim 6, wherein access of a computer to a clear object on the shared storage device is provided by virtual direct bus connection between the computer and the storage device.

9. A device for controlling access to data as in claim 3, wherein access of a computer to a protected object on said shared storage device is prevented by at least three levels of protection selected from; a custom proprietary file system used in the protected partition where protected objects are disposed which cannot be mounted by conventional operating systems, encryption of said directory of the partition, encryption of the content data files and only the TCP/IP protocol is used with interconnection to a computer, and the http “get” command is disabled for addresses in the protected partition.

10. A device for controlling access to data as in claim 3, wherein said shared storage device is selected from the group of; hard disk drives, optical disk recorders, semiconductor memory sticks and flash drives.

11. A method to control access to both copy-protected and clear AV objects received from an AV content source device, by an AV content sink device comprising the steps of partitioning said storage device into protected and clear sectors, directing copy-protected objects to said protected sector; and further directing clear objects into said clear sector.

12. A method to control access to both copy-protected and clear AV objects received from an AV content source device as in claim 11, further comprising the step of providing a custom file system, including a directory for said protected sector not addressable by conventional file systems.

13. A method to control access to both copy-protected and clear AV objects received from an AV content source device as in claim 12, comprising the further step of encrypting said directory of said custom file system.

14. A method to control access to both copy-protected and clear AV objects received from an AV content source device as in claim 12, comprising the further step of encrypting copy-protected objects.

15. A method to control access to both copy-protected and clear AV objects received from an AV content source device as in claim 12, wherein access to clear content is provided by making a virtual direct bus connection between sink and source device.

16. A method to control access to both copy-protected and clear AV objects received from an AV content source device as in claim 12, further comprising the step of checking for the existence of a device certificate for the sink device, in a preliminary validation step, before performing authentication.

17. A method to control access to both copy-protected and clear AV objects received from an AV content source device as in claim 12, wherein access to protected content is denied by not decrypting the content bit stream.

18. A method to control access to both copy-protected and clear AV objects received from an AV content source device as in claim 12, wherein access to protected content is denied (blocked) by physically switching signal transmission off.
